(19) United States
(12) Patent Application Publication
(10) Pub. No.: US 2009/0019532 A1
(43) Pub. Date: Jan. 15, 2009

(54) COMMUNICATION SYSTEM

(75) Inventors: Niels Ebbe Jacobsen, Dragor (DK); Alex Race, Camberley (GB); Debbie Race, Reading (GB)

Correspondence Address: FOLEY & LARDNER LLP, 321 NORTH CLARK STREET, SUITE 2800, CHICAGO, IL, 60610-4764, US

(73) Assignee: NOKIA CORPORATION

(21) Appl. No.: 10/583,838

(22) PCT Filed: Dec. 17, 2004
(86) PCT No.: PCT/IB2004/004321

§ 371 Date: Oct. 3, 2008

(30) Foreign Application Priority Data
Dec. 29, 2003 (GB) 0330109.0

(51) Int. Cl. H04L 9/32; G06F 15/16

(52) U.S. Cl. 726/5; 709/206

(57) ABSTRACT

A communication system for providing instant messaging and presence services among users of a communications network. The system comprising a user subscribed to the service and arranged to send a plurality of requests, each request comprising a user identity corresponding to at least one user of a first set of users of the network. The system also comprising a server having an access point arranged to receive the requests from the user, and having a service element for providing the service and wherein a second set of users are subscribed to the service element. The system also having circuitry for checking which of the users in the second set match with the users in the first set.

### FIELD OF THE INVENTION

The present invention is concerned with instant messaging and presence services (IMPS) and in particular, but not exclusively, with the so-called Wireless Village system architecture to be used in wireless communication networks.

### BACKGROUND OF THE INVENTION

The terminology “instant messaging” has been broadly used to describe a number of communication services, wherein users of a communication network are able to communicate in a substantially real time manner over a communication network. Broadly speaking, instant messaging has been approached from two different perspectives.

Firstly, instant messaging services are well established over fixed line networks, for example the Internet, wherein instant messaging software enables PC desktop users to communicate with one another online in a substantially real time environment. The instant messaging service is hosted by a server (or a network of servers) operating on the fixed line network with the desktop PCs acting as clients. An instant message sent from a desktop client is received by the instant message server and is distributed to the intended recipient desktop client or clients.

Instant messaging software has been developed to allow online users to monitor the relevant status of other users, i.e. whether they have logged on or have logged out of the service. Programs such as Internet Relay Chat (IRC) are extensively used and have been around for some time. These chat programs enable online users to group together into particular chat rooms which are hosted by IRC servers. Typically, users log into these chat rooms on an ad-hoc basis using on-line aliases to chat with other users on subjects of common interest.

Other computer programs, for example AOL Instant Messenger™ have been developed, which allow desktop users to communicate directly with one another. These programs are also hosted by instant message servers but these servers differ from IRC servers in that they provide more advanced access controls. Typically, users will subscribe to a list of other users (friends, family etc.) which is maintained by the instant message server (known as a “buddy list”). In this way, on-line status information and the ability to receive instant messages can be limited to those users on the subscribed list.

A drawback with these services is that a general lack of interoperability prevents users of one instant message service from interacting with users on a competing instant message service. Furthermore, each instant message service comes with its own client software which usually has to be downloaded.

Secondly, instant messaging is also being approached from the wireless communication network perspective. For example, Ericsson™, Motorola™ and Nokia™ have developed Wireless Village (WV), which is a mobile Instant Messaging and Presence Service (IMPS) initiative formed in April 2001 to define and promote a set of universal specifications for mobile instant messaging and presence services. A white paper has been published by Wireless Village and is discussed in more detail later.

The Wireless Village initiative was set up as a result of a number of drivers. In particular, the three above-mentioned industry leaders recognised a number of growing trends. These included: the growing popularity of instant messaging applications in fixed networks such as the Internet, the explosive growth of SMS (Short Message Service) text messages between mobile stations in a wireless communication network, and the need for an open industry specification to ensure open interfaces and interoperability between applications and web technologies.

The Wireless Village IMPS includes four primary features; i) presence, ii) instant messaging, iii) groups, and iv) shared content. As explained in the White Paper, the first feature, i.e. presence, is the key enabling technology for the Wireless Village initiative. In the existing desktop-based instant messaging services, the presence values are usually very simple, such as user is active, absent, not willing to communicate, off-line etc. These values generally reflect the user's ability or willingness to communicate via instant messaging. However in the Wireless Village model, presence takes on a richer meaning. For example, a user's presence can be defined in terms of independent attributes such as: device availability (phone is on, off, or in a call), the status of the user (available, unavailable, or in a meeting), location information, user device capabilities (voice, text, GPRS [General Packet Radio Services], multimedia, etc) and searchable personal statuses such as mood (happy, angry, etc) and hobbies (football, fishing, computing, dancing, etc).

Currently, the most common presence attributes specified are “Availability status”, “Message”, and “Icon”. Examples of these attributes are as follows:

i) Availability status: this is similar to the traditional presence values available on desktop clients, and is indicated by a graphic representing the user's willingness or ability to communicate (note: not available is indicated when the user is logged off the WV server). FIG. 1 shows example of some of the graphic symbols that might be used to indicate a user's presence.
ii) Message: a text string that a user enters as a personal message available to other subscribed users, e.g “At home”.
iii) Icon: an image or logo that can be selected by the user to, for example, indicate his personal interests or to reinforce the presence message. For example the icon shown in FIG. 2 indicates the user is at home.

It is useful at this point to distinguish between different terminologies used in relation to the Wireless Village (WV). That is, a user wishing to use the WV service for the first time will need to register to the WV service. Registration may incur charges based on, for example, initial registration, on-going usage on a monthly basis, time connected to the server, or the amount of data transmitted/received. However, the exact service charging method is flexible and beyond the scope of the present invention.

A user registered to the WV service is able to “connect” to a WV server using a client device such as a mobile phone. Once connected, the registered user can then choose to “subscribe” with another registered user to obtain, for example, presence information of the other registered user. Users who are not registered with the WV service cannot connect to the WV server, whereas registered users can connect and disconnect as they please. Registered users who are “connected” to a WV server can decide whether to subscribe or unsubscribe to other registered users.

If a registered user (User A) decides to disconnect from the WV server, this simply means User A cannot see the presence of other registered users, but has no effect on other registered users being able to see the presence of User A or being able to subscribe to User A.

Early users of the WV (Wireless Village) system might wish to communicate initially with their close friends or family using mobile IMPS, only to discover that these friends and family do not have handsets enabled with IMPS capability. The next logical step might be to check which of their extended group of friends or family are available on the WV server. However, there is no solution for checking which friends or family members are on the WV server. Instead, a user can only attempt subscribing to another user by single requests, i.e. one request at a time.

For example, a User A who wants to subscribe to and see another User B's presence, needs to send User B's Wireless Village Identity (WV-ID) or some other form of identification to a WV server, which in response checks to see if User B is registered to the WV service. If User B is indeed registered then User A is subscribed to User B which allows User A to see User B's presence. However, if User B is not registered to the WV server, then the request to subscribe and see User B's presence fails. Thus, if a user wishes to see the presence of a large group of friends, the user will need to request a subscription for each friend one at a time.

An alternative solution might be to allow users to browse on the relevant WV server, which would allow the user to see everybody registered to the WV service. However, there are two main drawbacks with this approach. On one hand, access to lists of names may present privacy concerns, but more importantly the size of the lists may present a heavy load on the wireless communication system which in turn will result in slow service.

It is an object of an embodiment of the present application to allow a user to check which of a plurality of contacts are registered to a service of an IMPS server and which overcomes the aforementioned disadvantages.

### SUMMARY OF THE INVENTION

According to one aspect of the present invention there is provided a communication system comprising: a server having a service element for providing the service and a data store for storing the identities of users of the communication system that are registered to the service; a user terminal that is capable of initiating verification of the registration of one or more users of the communication system to the service by transmitting to the server one or more messages indicating the identities of the said one or more users; wherein: the user terminal has a data store arranged for storing a plurality of user identities forming a first set of users, and the user terminal has a user interface arranged to present to a user of the terminal a single command option in response to selection of which the user terminal automatically transmits to the server one or more messages indicating the user identities of the first set of users for verification of which users of the first set are registered to the service.

According to another aspect of the present invention there is provided a method for checking which users of a communications network are registered to a service of the network, the method comprising: storing the identities of the users of the communication network that are registered to the service in a server; storing a plurality of user identities of the communications network in a user terminal as a first set of users; presenting a single command option via a user interface to a user of the user terminal; in response to the selection of the command option, automatically transmitting one or more messages indicating the user identities of the first set of users to the server; and verifying by means of the server which users of the first set are registered to the service.

According to a further aspect of the present invention there is provided a user terminal capable of operation by a user for registering to a server of a communication network, the user terminal comprising: a data store for storing a plurality of identities of other users of the network; a user interface arranged to present to the user of the user terminal a single command option, and a translation element for cooperating with the user interface such that upon selection of the single command by the user, the translation element generates one or more messages which are automatically transmitted from the user terminal to the server for verifying which of the other users are registered to the server.

For a better understanding of the present invention and to show how the same may be carried into effect, reference will now be made by way of example to the accompanying drawings.

### BRIEF DESCRIPTION OF THE DRAWINGS

FIG. 1 shows examples of graphic symbols for indicating the availability of a user;

FIG. 2 shown an example of an icon message indicating the availability of the user;

FIG. 3 shows a Wireless Village architecture in accordance with one embodiment of the present invention;

FIG. 4 shows the Wireless Village protocol stack in accordance with an embodiment of the present invention;

FIG. 5 shows a mobile phone in accordance with one embodiment of a user interface of the present invention;

FIG. 6 shows the sequence of operations displayed on a user interface according to one embodiment of the present invention;

FIG. 7 shows an example of a contacts database stored in a mobile phone according to one embodiment of the present invention;

FIG. 8 shows a flow chart according to an embodiment of the present invention; and

FIG. 9 shows a flow chart of the comparison process according to one embodiment of the present invention.

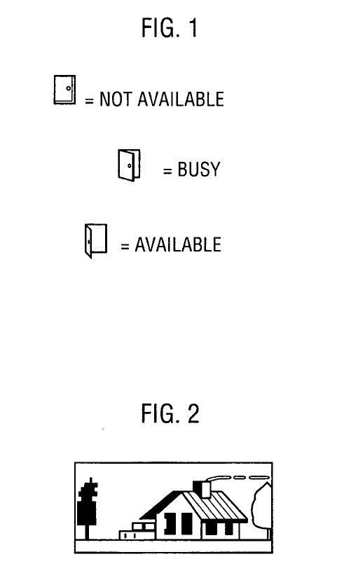

### DESCRIPTION OF THE PREFERRED EMBODIMENT

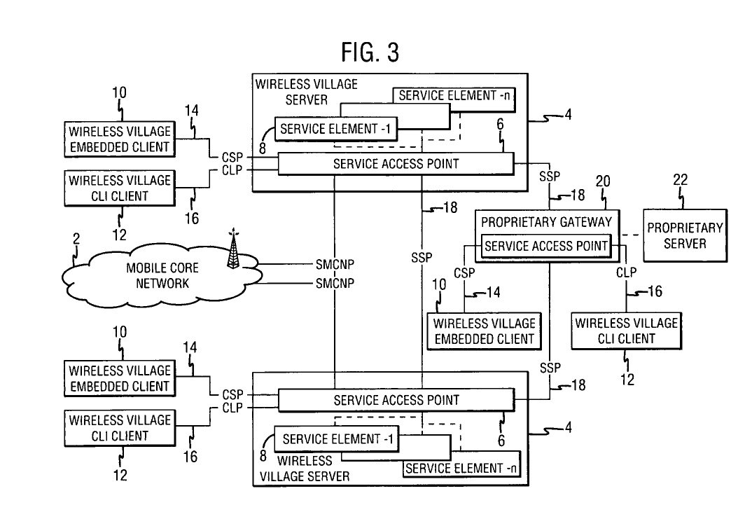

FIG. 3 of the drawings shows a Wireless Village system architecture in accordance with an embodiment of the present invention. A mobile core network 2 is shown, which could for example be a PLMN (Public Land Mobile Network) and which is shown as being connected to a Wireless Village server 4. It should be appreciated that the mobile core network 2 could comprise any existing 2G or 3G technologies, for example the standard GSM network being divided into cells which are broadcast by base transceiver stations (BTS), which are controlled by base station controllers (BSC), and which in turn are controlled by main switching centres (MSC). It should also be appreciated that 3G technologies can be used, for example the BTSs can be replaced by nodes and the BSCs can be replaced by radio network controllers (RNC). Also various known technologies, for example EDGE (Enhanced Data for GSM Evolution) or GPRS (General Packet Radio Service) can be used in the core network by providing the relevant SGSN (Serving GPRS Support Node) and GGSN (Gateway GPRS Service Node).

The WV system architecture can be described predominantly as a client-server based architecture, but also offers server-server capabilities for interoperability with legacy systems or proprietary technologies. However, the main mode of operation is in a client-server mode, wherein the server is the WV server 4 (often referred to as an IMPS-server) and the client can be either a mobile station, or other services/applications, or fixed desktop clients. The Wireless Village system is designed to offer seamless operation for both mobile and fixed line networks, and includes support for traditional SMS texting (performed in the mobile sense) and instant messaging (for example as performed in fixed line networks).

The WV service typically operates over a network of WV servers, which communicate with each other by means of a server-to-server protocol (SSP). A special type of WV server known as a proprietary gateway server 20 provides a gateway to non-WV services hosted by a proprietary server 22.

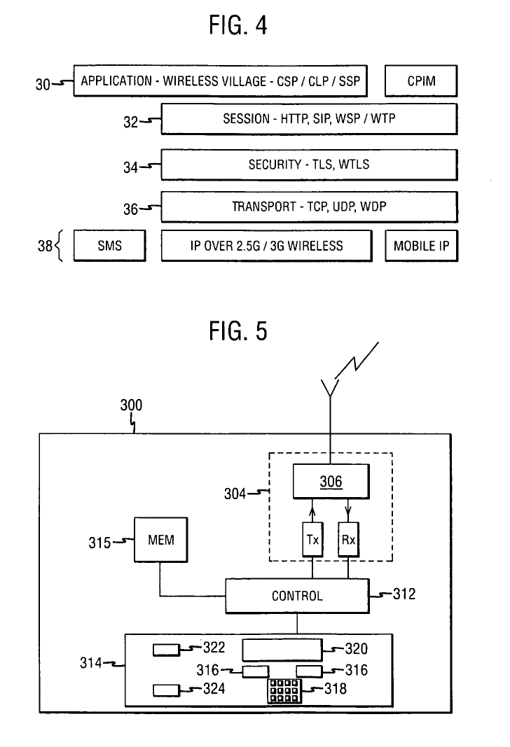

FIG. 4 shows the Wireless Village protocol stack according to an embodiment of the present invention. More particularly, the top level 30 of the protocol stack is known as the WV protocol suite which consists of a CSP (Client-Server Protocol), a SSP (Server-to-Server Protocol) and a CLP (Command Line Protocol).

It can be seen from FIG. 4 that the underlying layers of the protocol stack 32, 34, 36 and 38 can encompass a range of different protocols and technologies. The philosophy behind the Wireless Village in that where possible, the protocol stack should make use of existing Internet and Web technologies. Most of these technologies are already widely specified and therefore result in easy implementation and interoperability.

It should also be understood that the Wireless Village protocol uses XML (Extensible Markup Language) to represent the protocol data being exchanged during an IMPS session. There are also other techniques which have been adopted for the Wireless Village, for example MIME-type (Multipurpose Internet Mail Extensions) messages have been adopted for registering the format of the IMPS protocol messages. The use of existing standards is demonstrated in FIG. 4 in that the network layer 38 can either use SMS text messages between mobile users or IP (Internet Protocol) messages for instant messaging between desktop computers over the Internet.

Referring back to FIG. 3, it is now useful to discuss the client-server mode of operation of the Wireless Village architecture. As already described a client can take the form of a mobile station or a desktop computer, which is able to access various service elements 8 of the Wireless Village server 4. It should be appreciated that these service elements 8 are representative of the four primary features of the Wireless Village IMPS. That is, the service elements 8 represent: a presence service element, an instant messaging service element, a group service element, and a content service element.

As explained above, the presence service element has more meaning in the WV than in the desktop world, wherein for the latter, users merely announce their status to other authorised users. Instead, the presence service for IMPS can be defined in terms of a variety of different attributes. It should be appreciated that the presence service as provided by a presence service element 8 within the WV server 4, can be specified in terms of presence attributes. Presence information is typically of a personal nature and it is therefore only made available to whoever the user wishes. Therefore, access to presence information is controlled by the user himself.

The instant messaging service has already been described and is a familiar concept in both the mobile and desktop applications.

The group service element provides the ability for users to invite friends, family or people with a similar interest to chat in group discussions. Network operators can therefore build common interest groups where users can meet each other online.

The content service element allows users to share information, for example multimedia content such as pictures and music, which can be downloaded by other users that are authorised to use the service. The service can also be used to share files within groups in an instant messaging or chat session.

Each WV server 4 comprises a Service Access Point (SAP) 6, which serves as an interface between the WV server and its environment. The SAP 6 has interfaces to the WV clients 10, 12, other WV servers, the mobile core network 2, and proprietary gateways 20 to other non-WV servers. The functionality of the SAP includes authentication and authorisation, service discovery and service agreement, user profile management, and service relay.

The Wireless Village client of the architecture shown in FIG. 3 may be one of an embedded client 10 or a Command-Line Interface (CLI) client 12. The WV client 10, 12 communicates with the WV server 4 to carry out the IMPS features and to provide users with IMPS services. The Client-Server Protocol (CSP) shown on line 14 allows embedded clients (in either mobile stations or desktop clients) access to the WV server 4. The Command-Line Protocol (CLP) facilitates communication between the WV server and the CLI client allowing interaction with each other to support IMPS services within the legacy CLI client.

The CLI client uses text messages to communicate with the WV server. The functionality provided could be a subset of the functionality provided by an embedded client. An example of the CLI client is a mobile phone that uses SMS to communicate with a WV server.

The mobile phone of FIG. 5 functions as a mobile station and comprises an antenna 302 connected to RF circuitry 304. The RF circuitry has a duplexing unit 306 arranged to handle signals to be transmitted 308 and received 310 (for example using a transceiver) from a radio network. A control processor 312 is connected to the RF circuitry whereby the control processor may provide data to the RF circuitry to be transmitted to the radio network, and may receive data from the network via the RF circuitry. The control processor is connected to a user interface 314. The user interface having input and output apparatus. The input apparatus including a microphone 324, soft keys 316 and a keypad 318. The output apparatus including a visual display 320 and a loudspeaker 322. The soft keys 316 on the mobile phone allow the user to select the various options that are generated on the visual display, for example to scroll down a list of options displayed on the screen.

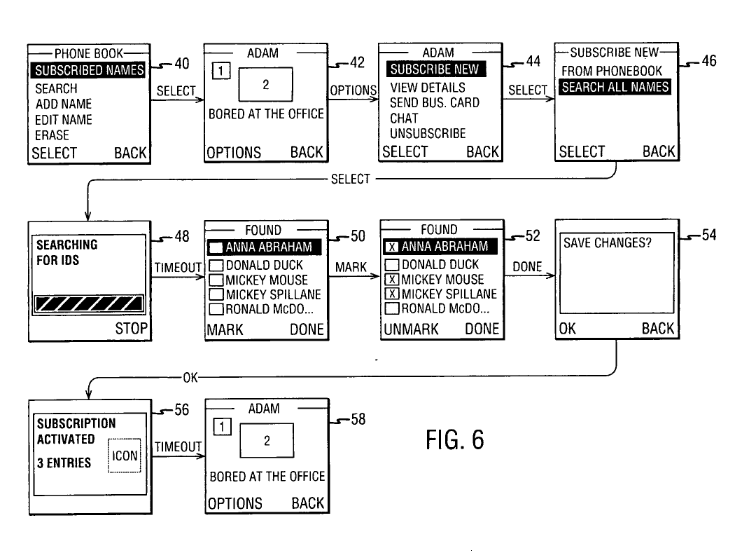

FIG. 6 shows the visual display 320 of the user interface of the mobile phone of FIG. 5. The mobile phone or station acts as a client device, specifically a WV embedded client 10 in the described embodiment, enabling a user to make use of the presence service element 8 of the WV server 4. More particularly, FIG. 6 shows a sequence of screen displays of the user interface, which appear as successive stages on the user's mobile station. The user is able to interact with the presence feature of the WV server via the user interface to obtain the presence information required.

At step 40, the user interface shows a list of possible options available to the user of the mobile station. The user selects the entry labelled “Subscribed names” which as the name suggests would be a group of users, which the user has subscribed to. At step 42, the first entry in the group of subscribed users is displayed together with the respective presence attributes. In this example, the subscribed user “Adam” is displayed and his presence message explains that he is “Bored at the office”. Additionally, the presence attributes Availability Status 1 and Icon 2 are also displayed. Other subscribed users can be displayed with their presence attributes by, for example, selecting up and down scroll keys (not shown).

If the user selects the “Options” command then an options menu is presented on the display as shown at stage 44. At stage 44, the user can select from a variety of options including a “chat” option, which will allow the user to chat with “Adam” or alternatively an “unsubscribe” option, which will unsubscribe the user from “Adam”, i.e. the user will no longer be able to see that Adam is “bored at the office”. However, in the embodiments shown the user will select the “Subscribe new” option, indicating that he wants to add a new user to the subscribed names group.

At step 46, the user is given two options. Either to select the contacts stored in the phone book of the mobile station (i.e. by selecting the “From phonebook” option) or alternatively the user can select the “Search all names” option. The “Search all names” command is translated by the user interface into a search and match operation, wherein comparison circuitry (not shown) will search the WV server 4 for all WV-IDs of registered Wireless Village users that match all contacts stored on the mobile phone. The results may then be reported as a list of matching WV-IDs.

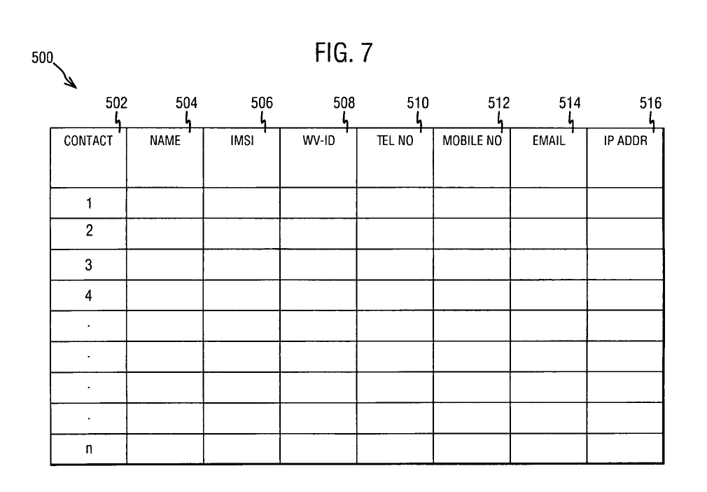

FIG. 7 shows a database 500 of the contacts stored on the mobile phone according to an embodiment of the present invention wherein the mobile phone will have memory 315 (shown in FIG. 5) in which such a database is stored and the control unit 312 is able to access the database as required. The database includes a plurality of records 1 to n identified in column 502, each record containing the details of a particular contact. The contact details are stored as data fields within the record. New contact records can be created by entering data via the mobile phone keypad 318, or by receiving contact records in the form of electronic business cards from other users. A user of the mobile can choose to store the contact details in whichever data fields are most appropriate. In the example shown, the details for each contact may be entered in one of the following exemplary fields:
“name” 504: which could contain either the full name, first name, surname or even a nickname of the contact.
“IMSI” 506: is the International Mobile Subscriber Identity, which is a unique identifier of a particular mobile phone that may belong to the contact.
“WV-ID” 508: is the Wireless Village identifier that may have been assigned to the contact. Normally, the mobile phone will not know what the WV-ID of a contact is since a WV-ID is only assigned by the WV server once a contact has been registered to the service. However, the user of the mobile phone may have received at some earlier time a message from a contact that includes that contact's WV-ID. In this case, the WV-ID will be stored in the database of the mobile phone. In such a situation it is necessary to perform a check at the WV server to confirm that the WV-ID for a particular contact is in fact correct (i.e. still relevant).
“Tel No” 510: is a fixed line telephone number, e.g. a PSTN (Public Switched Telephone Network) number, that may belong to the contact.
“Mobile No” 512: is a phone number of a particular mobile phone that may belong to the contact.
“Email” 514: is an email address of the contact.
“IP addr” 516: is the Internet Protocol address of a particular workstation connected to the Internet that may belong to the contact.

The searching and matching function may require a certain processing time indicated by the screen of the user interface shown at stage 48, after which, the matched names, i.e. those names corresponding to the contacts that are registered on the WV server, are found and are output to the user on the display shown at stage 50.

The comparison circuitry is responsible for comparing the list of contacts stored in the mobile station with the list of users registered with the presence service element 8 of the WV server 4.

According to one embodiment, the comparison circuitry resides within the WV server 4. When the user selects the “Search all names” command, the user interface informs the control processor 312 which responds by automatically searching for and keeping a record of suitable identification information in each of the contact records stored on the mobile phone. The control processor 312 then operates to send via the radio network the identification information to the WV server 4. The identification information used to distinguish between contact records and for performing the comparison process is flexible.

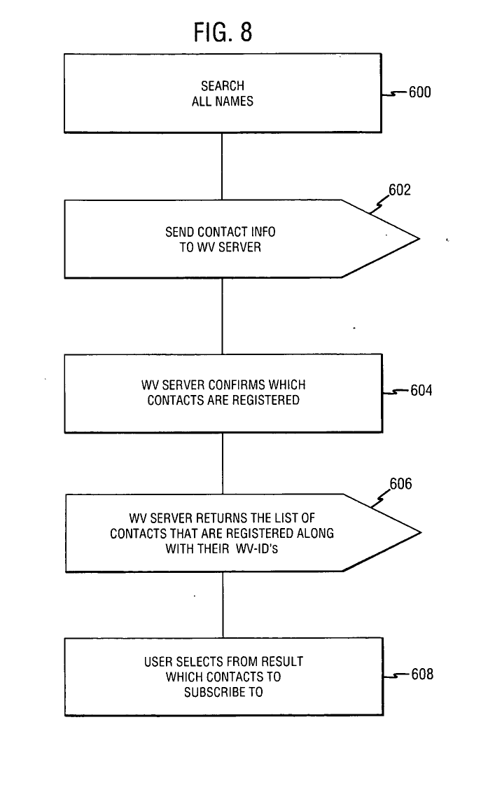

FIG. 8 shows one embodiment of the present invention, whereupon initiation of the “Search all names” command at step 600, the mobile phone sends contact information that uniquely identifies each contact stored on the mobile phone to the WV server at step 602. The WV server then confirms which of the contacts are indeed registered to the WV server at step 604 and returns a list of the contacts that are registered (along with their corresponding WV-ID's) to the mobile phone at step 606. The user of the mobile phone is then able to select which of the registered contacts he wishes to subscribe to at step 608.

It should be appreciated that there are in practice many different ways of implementing the present invention. For example, in relation to step 602, the contact information can be sent over the radio interface in different ways. That is, the information for the contacts stored on the mobile phone could all be sent in one message or alternatively could be sent in a plurality of successive messages. Moreover, the information that is sent at step 602 could be limited to contain only some of the fields for each of the records corresponding to each contact stored in the contact database, thereby reducing the required bandwidth. For example, only the user's mobile phone numbers would be sent whereupon the WV server would check which of those contacts are registered to the WV server and send those WV-ID's back to the user of the mobile phone. In yet a further embodiment, a plurality of different fields for each contact record could be sent with a priority attached to each field. In such a situation, the WV server will first search for those contacts having fields with the highest priority and identify whether those contacts are in fact registered to the WV server.

It should also be appreciated that an embodiment is envisaged wherein at least one of the contacts stored in the database on the mobile phone have at least two different mobile numbers for that contact. In such a case, both mobile numbers can be sent off to the WV server which is then able to search for whatever fields are matched, or alternatively a priority search can be given to one of the mobile numbers.

Therefore, broadly speaking the contacts database in the mobile phone may comprise one of three types of contact records:

1) contact information only, i.e. any of the fields shown in FIG. 7 which identifies each contact;
2) contact information and WV-ID, which means that at least one of the contacts has a WV-ID. It is therefore necessary that the WV-ID or the contact information is sent to the WV server to check that this WV-ID is still correct for the relevant contact.
3) contact information and WV-ID and subscribed, which means that the relevant contact has in fact subscribed to the WV server in the past. This can be confirmed by the WV server, or alternatively the contacts which are subscribed are ignored and the contact information of the other contacts in the database that are not subscribed are sent to the WV server for checking.

In another embodiment of the present invention, upon initiation of the “Search all names” command, the control processor 312 searches only for WV-IDs contained in each of the contact records stored on the mobile phone. The compiled list of WV-IDs is then sent to the WV server which compares the compiled list with its own list of WV-ID's that are registered to the server. The matching WV-IDs are then sent back from the WV server to the mobile station.

However, if the WV server maintains a database of registered users similar to the contacts database 500 in the mobile phone, then the comparison circuitry in the WV server is able to compare not just the WV-IDs but also other details relating to a contact. Accordingly, in another embodiment, upon initiation of the “Search all names” command, the control processor 312 searches for a single item of suitable identification information contained in each of the contact records in the following order of priority: WV-ID, then mobile phone number, then home phone number, then email address. Alternatively, the control processor 312 may search for all telephone numbers contained in each of the contact records, or even every detail contained in each of the contact records. In any case, the compiled list of identification information is then sent to the WV server which searches for each item of identification information in its database of registered users. Where the search finds a record containing a data field which matches (or maybe substantially matches) the item of identification information, the WV-ID corresponding to that record is added to a list of matching WV-IDs. The matching WV-IDs are then sent back from the WV server to the mobile station.

Alternatively, the search need not necessarily return the matching WV-IDs but may simply indicate in a message from the WV server to the mobile phone that one or more contacts have matching registration information on the WV server.

Clearly, at all stages in this process the relationship between the sent and received information must be arranged so as to enable correlation between the matching WV-IDs and the original contact records in the mobile phone.

Instead of choosing the “Search all names” option at step 46 in FIG. 6, the user may instead select the “From phonebook” option. In this option, the user is able to select, for example using the name field, an individual contact record from the contact database to search on the WV server. Of course, the contact database may have a plurality of contact details, such as different telephone numbers, associated with each contact record. In accordance with one embodiment, once the user has selected a contact record using the contact name field, the plurality of contact details for that contact record are sent off to the WV server which searches for each contact detail in its database of registered users. Where the search finds a record containing a data field which matches (or maybe substantially matches) the contact detail, the WV-ID corresponding to that record is sent back from the WV server to the mobile station.

In yet a further embodiment, if the database is present in the server, the WV server can verify that one of the mobile phone contacts is registered to a WV server and can then return a plurality of contact details associated with that registered contact to the mobile phone. The user can use this returned information to update the contact database on the mobile phone.

The WV server 4 having the comparison circuitry is then able to compare the identification information sent from the mobile station with the users that are registered to the presence server and compiles a list of matching WV-IDs which are returned to the mobile station. The matching WV-IDs are stored in the appropriate contact records in the contacts database, and the corresponding contact names are indicated as a list at stage 50 as previously described.

The user is then able to make use of a “Mark” command at stage 52 to select from a resulting list of matching names (i.e. contacts which are registered to the WV server), which of the contacts he wishes to subscribe to. Once the user has selected which contacts he wants to add to his subscribed list, he can then select the “Done” command and the next screen 54 requests the user to confirm the selection. Once confirmed, the control processor 312 flags the contact records corresponding to the selected names as being subscribed to the presence service. The control processor 312 also sends a subscription request with the WV-IDs corresponding to the selected contacts to the WV server which in turn subscribes the user to those selected WV registered users. At stage 56, the user interface displays to the user that the new subscription containing three entries has been activated.

In an alternative embodiment, the comparison circuitry could reside in the mobile station itself, whereby when the user selects the “search all names” command at stage 46 the user interface will translate this and signal to the WV server to send across a list of all the users subscribed to the presence service. This list is then received by the mobile station, which then performs a comparison with the users that are stored on the mobile station and produces a resulting list of the matched users.

In the described embodiments, the user of the mobile phone is able to issue a single command, i.e. “Search all names” 600 via the user interface 314 of the mobile phone 300. The mobile phone will have translation circuitry, for example a network interface element (not shown) located in the RF circuitry 304 of the mobile phone 300, which is responsible for translating the command issued by the user interface into a particular format of radio message(s) to be sent over the radio interface between the mobile phone and the WV server. The “search all names” command 600 is translated by a network interface element into whatever radio format message is deemed most appropriate. Therefore, a user of a mobile station to determine via a single command (i.e. “search all names” 600) which of his contacts are registered to the WV server.

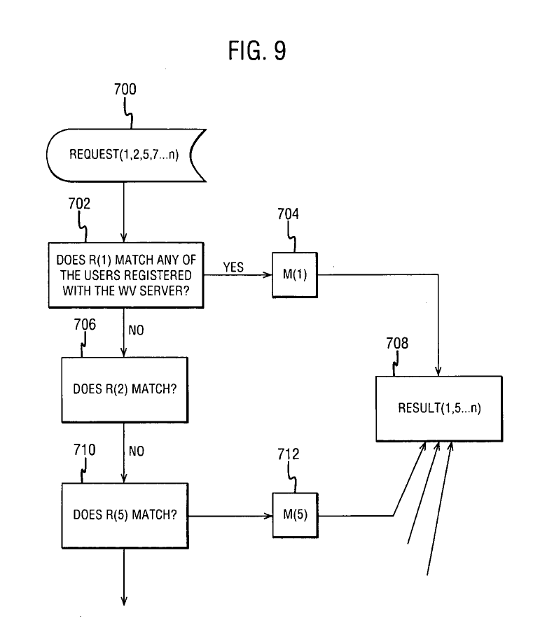

FIG. 9 shows a flowchart of one embodiment for implementing the comparison step 604 at the WV server. That is, a request message REQUEST(1, 2, 5, 7, 12 . . . n) is received by the WV server. The request message comprises identification information for a plurality of the contacts stored on the mobile phone. The identification information for the first contact R(1) is then compared at block 702 to the identification information of all of the user registered with the WV server and if there is a match then the identification information for the relevant contact is identified as a match M(1) indicated by block 704. If there is no match, the next identification information for the second contact R(2) is checked and so on. Finally, all the matched contacts are formed into a list which is sent 610 with a result message RESULT(1, 5 . . . n) back to the user's mobile phone. The user of the mobile phone receives the result message and determines which of the registered contacts to subscribe to.

It should be understood that the circuitry for performing the comparison can take on many forms, for example the circuitry could have parallel processing elements so that all the requests are searched at the same time, i.e. by performing the comparison in parallel.

The searching function is useful for both the instant messaging as well as for presence data. For instant messaging one user can communicate with another user via a server in a substantially real-time manner. Instead for presence data, considering the previous example, a user Adam could update his status “Bored at the office” by sending presence data to the WV server. This presence data would be stored in the server where it would remain in an unchanged state until Adam updated his status. If another user, John, requests the presence of user Adam then user John would receive a message from the WV server indicating that Adam was “Bored at the office”. Therefore, whereas instant messaging is affected in a substantially “real time” manner, the WV server which maintains the presence information does not have to involve a “real time” message between two users. However, in the presence embodiment user John would obtain a substantially instant message from the WV server regarding the status of Adam, although Adam may have sent his status to the network server some time previously.

Because the searching and matching operation according to an embodiment of the present invention is performed for all contacts stored in the mobile phone simultaneously, rather than on a on-by-one basis, the user is quickly and efficiently able to establish which of the contacts is subscribed to the presence service of the WV server. That is, the searching and matching operation can be performed in one process, rather than checking one at a time whether each relevant user is subscribed to the presence service. The search and matching operation results in a matched list, which could contain: no names (i.e. none of the requested contacts were on the server), one name (i.e. one of the contacts is subscribed to the server) or a list of names (i.e. more than one contact was subscribed to the server). The user is then able to select from the resulting matched list which contact to subscribe to. This encourages the usage of the presence service for the IMPS server substantially as compared to a one-at-a-time subscription approach, which is tedious and time consuming.

In an alternative embodiment, an even quicker way of performing the searching and matching operation is to ignore steps 50, 52 and 54 described in relation to FIG. 6 of the preferred embodiment. Instead, the list of contacts which is found to match is stored directly to memory, rather than displaying this on the screen of the user interface and giving the user the opportunity to select which contacts. Effectively steps 50, 52 and 54 of FIG. 6 would be replaced with a screen displaying, for example, “20 contacts found—save all?” This allows the user to save all names quickly rather then going through a selection process.

Although in the described embodiment a “Search all names” command was used which was translated into performing a search and match operation on all contacts stored on the mobile station, it should be appreciated that other commands could be used. The user interface could be setup to provide other command options where only a particular selection of names stored on the mobile phone could be sent to the WV server via a single command. For example, the display of the user interface at stage 46 of FIG. 6 shows another command option “From phonebook”, which are the contacts stored on the mobile phone that are stored in the user's phone book. Other command options may be provided for example an option whereby searching is performed for all the other contacts stored on the mobile phone which are not in the user's phone book. In any event, the feature which is common to all of these commands is that the user is able to send to the WV server a plurality of names by issuing a single command on the user interface of the mobile station. Therefore, a single command rather than one at a time will still be effected on the user interface, but on a customised set of contacts stored on the user's mobile phone.

It should also be appreciated that in an alternative embodiment, the user does not store his contacts on his user station. Instead a request is sent along with the relevant user identity information of the relevant contact to the WV server. Thus, some of the contacts can communicate their identity information to the user over a voice channel (wherein said contact identity information is not necessarily stored on the user station) and the user station can send this to the WV server.

It should also be appreciated that although the word “mobile phone” has been used to describe the client in the preferred embodiment, IMPS is specifically concerned with the ability of different clients to operate in the network. For example, the mobile station could be replaced with desktop computers, PDA's (Personal Digital Assistants), other handheld devices, etc.

It should also be appreciated that WV IMPS is intended to be used seamlessly across different networks, for example, wireless communication networks, fixed line networks (for example the Internet), and their related variants. That is, the WV client 10 shown in FIG. 3 can either be embedded in a mobile phone of a wireless communication network or alternatively in a desktop computer forming part of a fixed line network such as the Internet.

It should be appreciated that the record fields shown in the contacts database 500 of FIG. 7 are examples only and the list is non-exhaustive so that other identifier fields may be used to uniquely identify each contact.

The above described embodiments of the present invention allow a user to check with a single command on the user interface whether contacts stored on the user station are in fact registered to a service of the IMPS server and then the user has the ability to selectively subscribe to one or more of the registered contacts.

There follows a discussion of the white paper on the Wireless Village initiative to further describe technology relating to embodiments of the present invention.

The Wireless Village initiative is about building community around new and innovative Mobile Instant Messaging and Presence Services (IMPS). Instant Messaging and Presence is moving from the desktop and Internet to the mobile domain. Ericsson, Motorola and Nokia recognise the need for an industry standard for mobile IMPS. These companies formed the Wireless Village Initiative to ensure the interoperability of wireless messaging services and IM in particular.

### 1 BACKGROUND OVERVIEW

Today's wireless landscape is rapidly changing as mobile phones and networks are being enhanced to provide services beyond just voice services. The wireless industry is now seeing the rapid expansion of mobile data services. This expansion is being fueled by a variety of factors:

Internet and wireless domains are converging
Tremendous adoption rates of SMS and its lucrative business model
Mobile consumers and professionals are asking for new wireless applications
Operators need to leverage their investment in 3G spectrums
Operators are extending their brand to consumers via portals and new services.

Chief among the technologies consumers are asking for is mobile instant messaging and presence services (IMPS). Research Portal.com reports instant messaging is the Number Two requested application after voice. With the monumental growth patterns of SMS, where 10 billion messages are sent every month globally according to the GSM Association, and the adoption rate of desktop instant messaging (IM), with over 100 million registered users and over 50 million regular users as reported by Jupiter Media Metrix, we foresee that wireless IMPS will capitalize on both these trends.

Today, the world of desktop IM can be characterized by multiple, competing, proprietary systems and a lack of interoperability that is reminiscent of the early stages of email development. One of the challenges in bringing IM to the wireless market is to enable a standards-based approach that supports the goals of interoperability and roaming, ensuring the success of an application that will be as popular as email.

It is the goal of the Wireless Village initiative to ensure interoperability of mobile instant messaging and presence services while building community both around the initiative and through the deployment of innovative new IMPS services.

It is the strategy of the Wireless Village initiative to help the wireless operator succeed in attracting and retaining customers, leveraging their investment in current 2 G and 2.5 G as well as emerging 3 G networks and increasing profits by providing a comprehensive solution that addresses both the network operator's requirements and the end-user's needs. The Wireless Village solution enables the operator to leverage their existing customer base, SMS usage patterns and business models—while attracting new customers, enabling partnerships with existing IM providers, providing new value-add services, all while building their own IMPS communities.

### 2 WIRELESS VILLAGE SOLUTION

The Wireless Village Instant Messaging and Presence Service (IMPS) includes four primary features:

### Presence

### Instant Messaging

### Groups

### Shared Content

Presence is the key enabling technology for the Wireless Village initiative. In the desktop world users have been able to announce their status to authorized recipients, facilitating instant messaging.

In the Wireless Village model, Presence takes on a richer meaning. It includes client device availability (my phone is on/off, in a call), user status (available, unavailable, in a meeting), location, client device capabilities (voice, text, GPRS, multimedia) and searchable personal statuses such as mood (happy, angry) and hobbies (football, fishing, computing, dancing). Since presence information is personal, it is only made available according to the user's wishes—access control features put the control of the user presence information in the users' hands.

Instant Messaging is a familiar concept in both the mobile and desktop worlds. Desktop IM clients, two-way SMS and two-way paging are all forms of Instant Messaging. Wireless Village will enable interoperable mobile IM in concert with other innovative features to provide an enhanced user experience.

Groups or chat are a fun and familiar concept on the Internet. The Wireless Village initiative enables both operators and end-users to create and manage groups. Users can invite their friends and family to chat in group discussions. Operators can build common interest groups where end-users can meet each other online.

Shared Content allows users and operators to setup their own storage area where they can post pictures, music and other multimedia content while enabling the sharing with other individuals and groups in an IM or chat session.

These features, taken in part or as a whole, provide the basis for innovative new services that build upon a common interoperable framework. The Wireless Village initiative will use its community of supporters as a forum in which to test that framework.

### 3 WHO BENEFITS FROM THE WIRELESS VILLAGE SOLUTION?

Everyone benefits from the Wireless Village solution:
End Users
Device Manufacturers
Service Providers
Application Developers

End users benefit from the Wireless Village services—which work from any device, be it a mobile phone or desktop PC, on any network—by knowing they can communicate with their friends and family.

Device Manufacturers benefit by having only to implement a single protocol to support a common set of widely adopted features. The cost reductions made possible through strong industry support of a common protocol are necessary given the constraints on mobile devices: low power consumption, storage space, memory and cost.

Service Providers offering Wireless Village services benefit from having to deploy a single server solution that will address multiple customer needs while interoperating seamlessly across multiple devices.

Application Developers have a common framework upon which they can build new services for presence, messaging, group and content delivery.

### 4 THE CHARACTERISTICS OF THE WIRELESS VILLAGE SOLUTION

### 4.1 An Open Industry Specification to Ensure Interoperability

In order for IMPS to be successful, it is imperative that client devices, both mobiles and PCs can interoperate. To ensure interoperability and the widespread adoption of the solution, the Wireless Village initiative is promoting jointly developed architecture and protocols as industry specifications.

### 4.2 Enabling the Operators to Build Persistent Communities

One of the key benefits to the operator in deploying the Wireless Village solution is the ability to brand the service and build an end-user community. Friends and colleagues want to be able to communicate with each other independent of location, time or device constraints. We predict that the inherent mobility of wireless devices, coupled with an IM solution that leverages the desktop PCs, will very quickly drive the creation of persistent IMPS communities.

### 4.3 Open Interfaces to Support Partnerships

The Wireless Village specification defines how the IMPS system should interface with the existing wireless network infrastructures, as well as, providing an open interface to existing IM communities on the Internet. This enables operators to establish business relationships with existing IM providers such as AOL, ICQ, Yahoo, MSN and others.

Gartner Group reports that messaging will be the #1 data revenue source for carriers for the next 5 years (39% in 2002 and 62% in 2005). The architecture and open protocol of the Wireless Village specification supports multiple server deployments such that the operator can host their own service, in addition to enabling the enterprise with their own IMPS servers. The Wireless Village initiative's flexible architecture and open interfaces help promote the widespread adoption of IMPS servers. Our expectation is that IMPS servers will become as prevalent as email servers in the near future.

### 4.4 Built Upon Existing Internet and Web Technologies

Where possible, the protocol makes use of existing Internet and Web technologies. These technologies are implemented widely and are well tested, so their use ensures easy implementation and interoperability testing.

XML, the Extensible Markup Language, is rapidly emerging as the lingua franca for representing structured data over the Web. To the greatest extent possible, the protocol uses XML to represent the protocol data being exchanged during an IMPS session.

IMPS activities in the IETF IMPP have received widespread interest throughout the industry. Although it is still in development, to the greatest extent possible, the Wireless Village initiative will support the CPIM draft and build upon it.

Other useful standards in this space include the Multipurpose Internet Mail Extensions (MIME) for registering the format of the IMPS protocol messages.

### 5 WIRELESS VILLAGE INTEROPERABILITY FRAMEWORK

The Wireless Village defines and promotes a set of universal standards and specifications for mobile instant messaging and presence services. The standards and specifications will be used for exchanging messages and presence information between mobile devices, mobile services and Internet-based instant messaging services. All will be fully interoperable and will leverage existing web technologies.

The Wireless Village interoperability framework includes the Wireless Village system architecture and an open protocol suite at the IMPS application level to provide interoperable mobile IMPS services among workstations, network application servers, and mobile information appliances such as mobile handsets, handheld computers, PDAs and other mobile devices.

### 5.1 System Architecture

The Wireless Village System Architecture, as shown in FIG. 3, describes the IMPS system and its relation to mobile networking and the Internet. This is a client-server based system, where the server is the IMPS server and the clients can be either mobile terminals, or other services/applications, or fixed PC-clients. For interoperability, the IMPS servers and Gateways are connected with a Server-to-Server Protocol (SSP). The architecture gives implementers more choices in Wireless Village Servers or Gateways, but with the Wireless Village brand and technology.

The Wireless Village Server is the central point in this system. It is composed of four Application Service Elements that are accessible via the Service Access Point. The Application Service Elements are:
Presence Service Element
Instant Messaging Service Element
Group Service Element
Content Service Element

The Wireless Village Client consists of an Embedded Client and a Command-Line Interface (CLI) Client. It communicates with the Wireless Village Server to accomplish IMPS features and functions and to provide users with IMPS services.

The Wireless Village System Architecture is consistent with 3GPP TS 22.121 Virtual Home Environment and 3GPP TS 23.127 Open Service Architecture. The interoperability between Wireless Village Servers and Clients, and between Wireless Village Servers is achieved through the Wireless Village Protocol Suite.

### 5.2 Protocol Suite

The Wireless Village Protocol Suite consists of the Client-Server Protocol (CSP), Server-Server Protocol (SSP) and Command Line Protocol (CLP). The protocol stack is shown in FIG. 4.

CSP is designed to provide Embedded Clients in mobile terminals and desktop clients access to the Wireless Village Server.

SSP is designed to provide the communication and interaction means among the Wireless Village Servers and the SSP Gateways. SSP allows the Wireless Village clients to subscribe to the IMPS services provided by different servers that are distributed across the network. SSP allows the Wireless Village clients to communicate with existing proprietary Instant Messaging networks through the SSP Gateway.

CLP is designed to provide the Wireless Village server and the CLI client with the means to communicate and interact with each other to support the IMPS services in a legacy CLI client.

The Wireless Village Protocol Suite runs at the application level, and is compliant with IETF RFC 2778, RFC 2779 and the IMPP CPIM model. The Wireless Village Protocol Suite may run independently over different transport layer and bearer protocols.

### 6 CONCLUSION

The Wireless Village initiative is a community-building effort. We endeavor to build a community of technology companies around a common standard, and to enable service providers to build their own end-user communities.

The Wireless Village initiative is an industry-leading coalition and a comprehensive solution that leverages a standards-based approach to wireless instant messaging and presence.

Ericsson, Motorola, and Nokia are leaders in wireless communications solutions.

The Wireless Village initiative is open to participation from all industry leaders that desire to support these specifications and help build this community.

1. A communication system comprising:
a server having a service element for providing the service and a data store for storing the identities of users of the communication system that are registered to the service;
a user terminal that is capable of initiating verification of the registration of one or more users of the communication system to the service by transmitting to the server one or more messages indicating the identities of the said one or more users;
wherein:
the user terminal has a data store arranged for storing a plurality of user identities forming a first set of users, and
the user terminal has a user interface arranged to present to a user of the terminal a single command option in response to selection of which the user terminal automatically transmits to the server one or more messages indicating the user identities of the first set of users for verification of which users of the first set are registered to the service.

2. The system according to claim 1, wherein the users that are registered to the service form a second set of users and the server comprises verification means for determining which users in the first set are also in the second set.

3. The system according to claim 1, wherein the server sends a result message to the user terminal, the result message comprising the identities of the users of the first set that are registered to the service.

4. The system according to claim 1, wherein the user interface is arranged to present to the user of the user terminal a farther command option for selecting which of the users of the first set that are registered to the service to subscribe to.

5. The system according to claim 1, wherein each user terminal is a client terminal and the communication system operates in a client-server mode.

6. The system according to claim 5, wherein the client terminal is arranged to communicate with the server using a fixed line network.

7. The system according to claim 5, wherein the client terminal is arranged to communicate with the server using a wireless communication network.

8. The system according to any of claim 5, wherein the client terminal is arranged to communicate with the server using at least one of a Client-Sever Protocol (CSP) and a Command Line Protocol (CLP).

9. The system according to claim 1, wherein the server is a wireless village server and the service element provides a presence service.

10. The system according to claim 9, wherein the presence service can provide information indicative of at least one of the following attributes: terminal availability, user status, user location, user moods and user interests.

11. The system according to claim 1, wherein the server is connected to a gateway server arranged to operate in a server-server mode.

12. The system according to claim 1, wherein each of the user identities is indicated by at least one of: a wireless village identifier, name, telephone number, IP address and email address.

13. The system according to claim 1, wherein each user identity having a plurality of telephone numbers associated therewith.

14. The system of claim 1 comprising a second user terminal which communicates with the user terminal via the server.

15. The system of claim 14, wherein the server is capable of transferring substantially instant messaging between the user terminal and the second user terminal.

16. The system of claim 15, wherein both of the user terminals are capable of sending presence data representing the status of their respective users to the server in an asynchronous manner, and the server is arranged to, on receiving that data, store that data, and subsequently, in response to the receiving a request from at least one of the user terminals for the presence data of the other user terminal, to transmit the stored presence data of the said other terminal in a substantially instant manner to the said one of the user terminals.

17. A method for checking which users of a communications network are registered to a service of the network, the method comprising:
storing the identities of the users of the communication network that are registered to the service in a server;
storing a plurality of user identities of the communications network in a user terminal as a first set of users;
presenting a single command option via a user interface to a user of the user terminal;
in response to the selection of the command option, automatically transmitting one or more messages indicating the user identities of the first set of users to the server; and
verifying by means of the server which users of the first set are registered to the service.

18. The method of claim 17, comprising the further steps of:
generating a third set of users of the communications network which are the users of the first set that are registered to the service;
sending said third set of users to the user terminal;
presenting a second command option via the user interface for allowing the user of the user terminal to select from said third set which of the registered users to subscribe to receive presence information on.

19. A user terminal capable of operation by a user for registering to a server of a communication network, the user terminal comprising:
a data store for storing a plurality of identities of other users of the network;
a user interface arranged to present to the user of the user terminal a single command option, and
a translation element for cooperating with the user interface such that upon selection of the single command by the user, the translation element generates one or more messages which are automatically transmitted from the user terminal to the server for verifying which of the other users are registered to the server.

20. The user terminal of claim 19, further comprising means for receiving from the server a result message indicating the identities of the other users that are also registered to the server.

21. The user terminal of claim 20, wherein the user interface is arranged to present a second command option enabling the user to mark one or more of the user identities received in the result message and a third command option for automatically subscribing to said marked users.

22. The user terminal according to claim 21, wherein the network is capable of supporting substantially real-time communications between the subscribed users.

23. The user terminal according to claim 21, wherein the server is an IMPS server which supports at least one of wireless instant messaging and presence data between the subscribed users.

24. A method for checking registration status of users, the method comprising:
storing a plurality of user identities in a user terminal as a first set of users;
presenting a single command option via a user interface to a user of the user terminal;
in response to selection of the command option, automatically transmitting one or more messages indicating the user identities of the first set of users to a server where identities of users that are registered to the service are stored for verification of the registration status of the users.

25. The method of claim 24, comprising receiving a result message indicating the identities of other users that are registered to the server.

26. The method of claim 25, comprising
presenting to the user a second command option enabling the user to mark one or more of the user identities received in the result message; and
presenting a third command option for automatically subscribing to said marked users.

27. The method of claim 26, comprising sending at least one of wireless instant messaging messages and presence data between the subscribed users.

28. A method for providing users with information of service registration status of other users of a communications network, the method comprising:
storing identities of users of the communication network that are registered to a service in a server;
receiving from a user terminal one or more messages indicating user identities of a first set of users, wherein the one or more messages are generated based on user identities of the first set of users as stored in the user terminal and automatically sent in response to selection of a single command option; and
verifying which users of the first set are registered to the service.

29. The method of claim 28, comprising determining which users in the first set are also in a second set, the second set comprising users that are registered to the service.

30. The method of claim 28, comprising sending a result message to the user terminal, the result message comprising the identities of the users of the first set that are registered to the service.

31. The method of claim 28, comprising:
generating a third set of users of the communications network which are the users of the first set that are registered to the service,
sending said third set of users to the user terminal for allowing the user of the user terminal to select from said third set which of the registered users to subscribe to;
receiving a subscription from the user terminal; and
sending presence information based on the subscription.

32. The method according to claim 28, comprising providing information indicative of at least one of terminal availability, user status, user location, user moods and user interests.

33. The method of claim 28, comprising transferring substantially instant messaging between at least two user terminals.

34. A server for providing users with a service via a communications network, comprising:
a service element for providing the service;
a data store for storing identities of users of the communication system that are registered to the service; and
a controller configured to process one or more messages received from a user terminal and indicative of user identities of a first set of users, wherein the one or more messages are generated based on user identities of the first set of users as stored in the user terminal and automatically sent in response to selection of a single command option, and to verify which users of the first set are registered to the service.

35. A program product, comprising machine readable program code for causing performing of the following steps:
storing a plurality of user identities in a user terminal as a first set of users;
presenting a single command option via a user interface to a user of the user terminal; and
in response to selection of the command option, automatically transmitting one or more messages indicating the user identities of the first set of users to a server where identities of users that are registered to the service are stored for verification of the registration status of the users.

36. The program product of claim 35, causing, subsequent to reception of a result message indicating the identities of other users that are registered to the server, performing of further steps of:
presenting to the user a second command option enabling the user to mark one or more of the user identities received in the result message; and
presenting a third command option for automatically subscribing to said marked users.

37. A program product, comprising machine readable program code for causing performing of the following steps:
storing identities of users of the communication network that are registered to a service in a server;
receiving from a user terminal one or more messages indicating user identities of a first set of users, wherein the one or more messages are generated based on user identities of the first set of users as stored in the user terminal and automatically sent in response to selection of a single command option; and
verifying which users of the first set are registered to the service.

38. The program product of claim 37, causing, subsequent to determining which users in the first set are registered to the service, performing of a further step of sending a result message to the user terminal, the result message comprising the identities of the users of the first set that are registered to the service.

39. The program product of claim 37, causing, subsequent to determining which users in the first set are registered to the service, performing of further steps of
generating a further set of users of the communications network which are the users of the first set that are registered to the service;
sending said further set of users to the user terminal for allowing the user of the user terminal to select from said third set which of the registered users to subscribe to;
receiving a subscription from the user terminal; and
sending presence information based on the subscription.
